(19) United States
(12) Patent Application Publication
(10) Pub. No.: US 2022/0035035 A1
(43) Pub. Date: Feb. 3, 2022

(54) LOW COST RANGE ESTIMATION TECHNIQUES FOR SATURATION IN LIDAR

(71) Applicant: Beijing Voyager Technology Co., Ltd., Beijing (CN)

(72) Inventors: Zhenghan Zhu, Mountain View, CA (US); Yue Lu, Mountain View, CA (US); John Wu, Mountain View, CA (US); Youmin Wang, Mountain View, CA (US)

(21) Appl. No.: 16/944,294

(22) Filed: Jul. 31, 2020

(51) Int. Cl. G01S 17/58; G01S 17/931; G01S 7/4865; G01S 7/487

(52) U.S. Cl. CPC G01S 17/58; G01S 7/4873; G01S 7/4865; G01S 17/931

(57) ABSTRACT

A range detection system is disclosed. The range detection system includes an optical source configured to emit an optical pulse toward an object, where the emitted optical pulse includes a peak intensity occurring at a first time, and where the emitted optical pulse is reflected from the object, whereby a reflected optical pulse is generated. The range detection system also includes an optical detector configured to receive the reflected optical pulse and to generate an electronic signal encoding the received reflected optical pulse, and a processor, configured to receive the electronic signal and to detect a leading edge occurring at a second time, detect a trailing edge occurring at a third time, and calculate an estimated time of a peak intensity of the reflected optical pulse based at least in part on a difference between the second time and the third time.

### TECHNICAL FIELD

The subject matter described herein relates to LiDAR systems, and more particularly to range estimation techniques in LiDAR systems.

### BACKGROUND

Modern vehicles are often fitted with a suite of environment detection sensors that are designed to detect objects and landscape features around the vehicle in real-time that can be used as a foundation for many present and emerging technologies such as lane change assistance, collision avoidance, and autonomous driving capabilities. Some commonly used sensing systems include optical sensors (e.g., infra-red, cameras, or other similar device), radio detection and ranging (RADAR) for detecting presence, direction, distance, and speeds of other vehicles or objects, magnetometers (e.g., passive sensing of large ferrous objects, such as trucks, cars, or rail cars), and light detection and ranging (LiDAR).

LiDAR typically uses a pulsed light source and a light detection system to estimate distances to environmental features (e.g., vehicles, structures, or other similar device). In some systems, the light source can be steered in a repeating scanning pattern across a region of interest to form a collection of points that are dynamically and continuously updated in real-time, forming a “point cloud.” The point cloud data can be used to estimate, for example, a distance to, a dimension of, and a location of an object relative to the LiDAR system, often with very high fidelity (e.g., within 5 cm).

Sometimes the environmental features can have highly reflective surfaces which can have deleterious effects on the ability of a LiDAR system to accurately estimate a distance of the object. New LiDAR systems are needed that are less sensitive to highly reflective surfaces.

### SUMMARY

One inventive aspect is a range detection system. The range detection system includes an optical source configured to emit an optical pulse toward an object, where the emitted optical pulse includes a peak intensity occurring at a first time, and where the emitted optical pulse is reflected from the object, whereby a reflected optical pulse is generated. The range detection system also includes an optical detector configured to receive the reflected optical pulse and to generate an electronic signal encoding the received reflected optical pulse, and a processor, configured to receive the electronic signal and to detect a leading edge occurring at a second time, detect a trailing edge occurring at a third time, and calculate an estimated time of a peak intensity of the reflected optical pulse based at least in part on a difference between the second time and the third time.

In some embodiments, the leading edge and the trailing edge of the electronic signal are each detected when the electronic signal crosses a predetermined threshold value.

In some embodiments, the predetermined threshold value is set at a percentage of a maximum value of the electronic signal.

In some embodiments, the estimated time of the peak intensity is calculated as an arithmetic mean of the second time and the third time.

In some embodiments, the estimated time of the peak intensity is calculated based on the arithmetic mean adjusted by an offset value.

In some embodiments, the offset value is determined based on a characterization of one or more optical signals received by the optical detector.

In some embodiments, the leading edge of the electronic signal is detected based on a first slope of the electronic signal, and the trailing edge of the electronic signal is detected based on a second slope of the electronic signal.

Another inventive aspect is a LiDAR receiver including an optical receiver configured to receive a reflected LiDAR pulse, and circuitry coupled to the optical receiver and configured to use a predetermined threshold intensity value to determine a time of a leading edge of the reflected pulse at a time when an intensity of the reflected LiDAR pulse crosses the predetermined threshold intensity value a first time, determine a time of a trailing edge of the reflected pulse at a time when an intensity of the reflected LiDAR pulse crosses the threshold intensity value a second time, and determine an estimated time of a peak intensity of the reflected LiDAR pulse using the time of the leading edge and the time of the trailing edge.

In some embodiments, the predetermined threshold intensity value is set at a percentage of a saturation intensity of the LiDAR receiver.

In some embodiments, the range detection system also includes the percentage is between 20 percent and 40 percent.

In some embodiments, the estimated time of the peak intensity is determined by calculating an arithmetic mean of the time of the leading edge and the time of the trailing edge.

In some embodiments, the estimated time of the peak intensity is offset from the arithmetic mean.

In some embodiments, a value of the offset is determined based on characterization of one or more received LiDAR pulses.

In some embodiments, the range detection system also includes a leading edge slope of the reflected pulse is determined at the first time and a falling edge slope of the reflected pulse is determined at the second time, and where at least one of the leading edge slope and the falling edge slope are used in the determining the estimated time of the peak intensity.

Another inventive aspect is a method of determining a distance to an object, the method including emitting an optical signal from an optical source toward the object, where the emitted optical signal includes a peak intensity occurring at a first time, where the emitted optical signal is reflected from the object, whereby a reflected optical signal is generated, receiving the reflected optical signal at an optical detector, generating an electronic signal encoding the received reflected optical signal, where the electronic signal encodes a leading edge occurring at a second time and a trailing edge occurring at a third time, calculating an estimated time of a peak intensity of the electronic signal at a fourth time based at least in part on the second time and the third time, and determining the distance to the object based at least in part on a difference between the first time and the fourth time.

In some embodiments, the method also includes determining the second time and the third time when the electronic signal crosses a predetermined threshold value.

In some embodiments, the predetermined threshold value is set between 20 percent and 40 percent of a maximum value of the electronic signal.

In some embodiments, the method also includes determining the second time based on a first slope of the electronic signal, and determining the third time based on a second slope of the electronic signal.

In some embodiments, the estimated time of the peak intensity is calculated by determining an arithmetic mean of the second time and the third time.

In some embodiments, the estimated time of the peak intensity is calculated by adding an offset value to the arithmetic mean

To better understand the nature and advantages of the present disclosure, reference should be made to the following description and the accompanying figures. It is to be understood, however, that each of the figures is provided for the purpose of illustration only and is not intended as a definition of the limits of the scope of the present disclosure. Also, as a general rule, and unless it is evident to the contrary from the description, where elements in different figures use identical reference numbers, the elements are generally either identical or at least similar in function or purpose.

### DESCRIPTION OF DRAWINGS

The accompanying drawings, which are incorporated in and constitute a part of this specification, show certain aspects of the subject matter disclosed herein and, together with the description, help explain some of the principles associated with the disclosed implementations.

FIG. 1 illustrates a schematic view of a LiDAR-based system mounted on a vehicle according to embodiments of the disclosure;

FIG. 2 illustrates a simplified block diagram showing aspects of the LiDAR-based detection system illustrated in FIG. 1;

FIG. 3 is a schematic diagram of a receive circuit of the LiDAR-based detection system illustrated in FIG. 1;

FIG. 4 is a graphical representation of an unsaturated digitized pulse of a light signal that can be processed by the receive circuit illustrated in FIG. 3;

FIGS. 5A and 5B are graphical representations of saturated digitized pulses of a light signal that can be processed by the receive circuit illustrated in FIG. 3; and

FIG. 6 is a simplified block diagram of computer system configured to operate aspects of the LiDAR-based detection system illustrated in FIG. 1.

When practical, similar reference numbers denote similar structures, features, or elements.

### DETAILED DESCRIPTION

Various details are set forth herein as they relate to certain embodiments. However, the invention can also be implemented in ways which are different from those described herein. Modifications can be made to the discussed embodiments by those skilled in the art without departing from the invention. Therefore, the invention is not limited to particular embodiments disclosed herein.

For purposes of explanation, specific configurations and details are set forth in order to provide a thorough understanding of the embodiments. However, it will be apparent to one skilled in the art that certain embodiments may be practiced or implemented without every detail disclosed. Furthermore, well-known features may be omitted or simplified in order to prevent any obfuscation of the novel features described herein.

In some embodiments a distance between the LiDAR system and an object of interest can be calculated by determining a time of flight (TOF) for a light pulse. In one embodiment the TOF is calculated by determining the elapsed time between a peak value of a transmitted light pulse and a peak value of a received light pulse that is reflected off of the object of interest. However, sometimes the object and/or the ambient conditions can cause the reflected light pulse to have a greater than normal intensity (e.g., the object is highly reflective or the object is very close to the LiDAR system). As a result the LiDAR system can “clip” these abnormally high intensity pulses such that a processor within the LiDAR system receives a reflected pulse that has the top portion of the pulse flattened or “clipped” or “saturated,” making it difficult for the system to identify the peak value of the received light pulse.

In some embodiments the LiDAR system can identify such “clipped pulses” and can calculate an estimated time of the peak intensity of the received pulse using a predetermined threshold intensity value. In some embodiments, the predetermined threshold intensity value can be set at a percentage of the maximum intensity of the LiDAR system and a leading edge of the received pulse can be identified where an intensity of the received pulse first crosses over the threshold and a trailing edge can be identified where the intensity of the received pulse crosses over the threshold a second time. The timing of the rising edge and of the falling edge of the received light pulse can then be used to calculate time of a peak value of the received light pulse which is used for the TOF calculation. In other embodiments one or more other values of the received light pulse may be used for the TOF calculation, as described in more detail below.

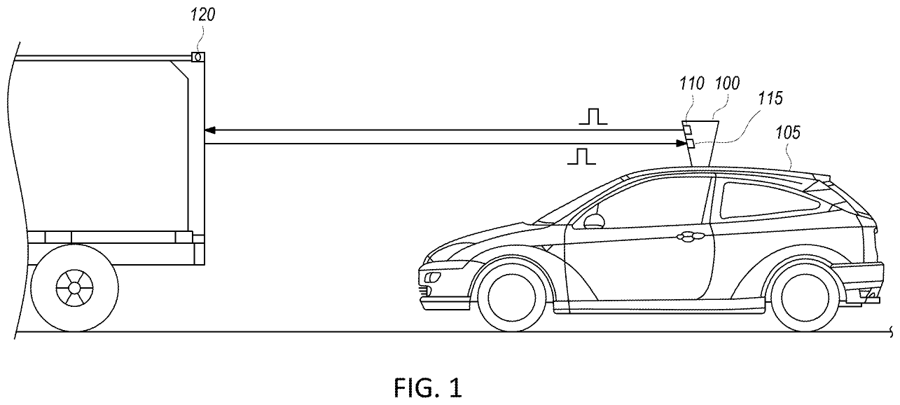

The following high level summary is intended to provide a basic understanding of some of the novel innovations depicted in the figures and presented in the corresponding descriptions provided below. Aspects of the invention relate to an LiDAR-based system. As an illustrative example, FIG. 1 depicts a LiDAR-based system 100 mounted on a vehicle 105 (e.g., automobile, unmanned aerial vehicle, or other similar device). LiDAR system 100 may use a pulsed light LiDAR source 110 (e.g., focused light, lasers, or other similar device) and detection system 115 to detect external objects and environmental features (e.g., vehicle 120, structures, or other similar device), determine a vehicle's position, speed, and direction relative to the detected external objects, and in some cases may be used to determine a probability of collision, avoidance strategies, or otherwise facilitate certain remedial actions.

LiDAR source 110 may employ a light steering system, for example, that includes a mirror that steers a pulsed light source also called a LiDAR beam. In some embodiments the mirror is manipulable and sequentially steers the LiDAR beam in a scan and repeat pattern across a large area to detect obstacles around the vehicle and to determine distances between the obstacles and the vehicle. The mirror can be part of a MEMS device that enables the mirror to be rotated about one or more axes (e.g., tilted). As the mirror is rotated to steer the LiDAR beam, knowledge of the mirror's position can be used to determine the direction the reflected LiDAR beam is pointing

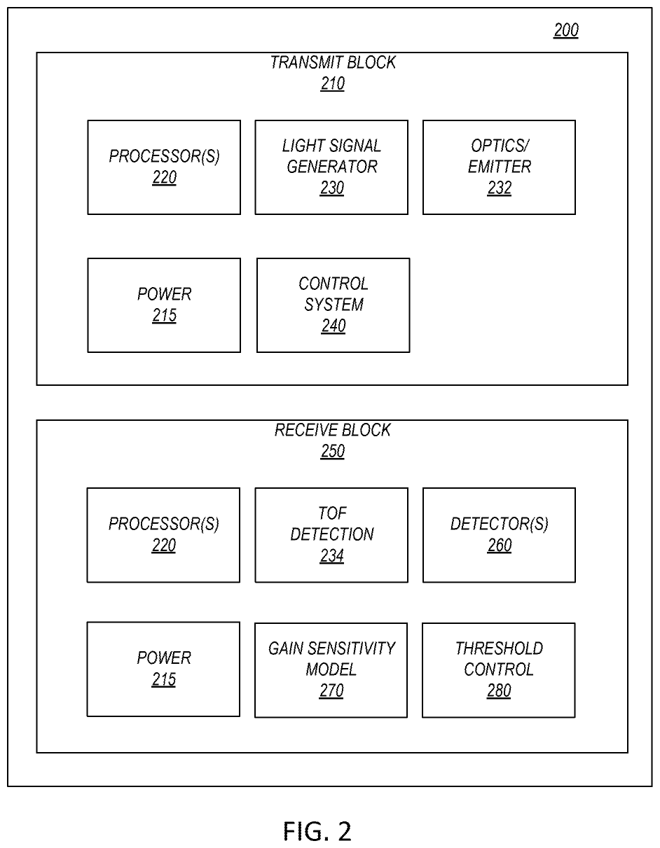

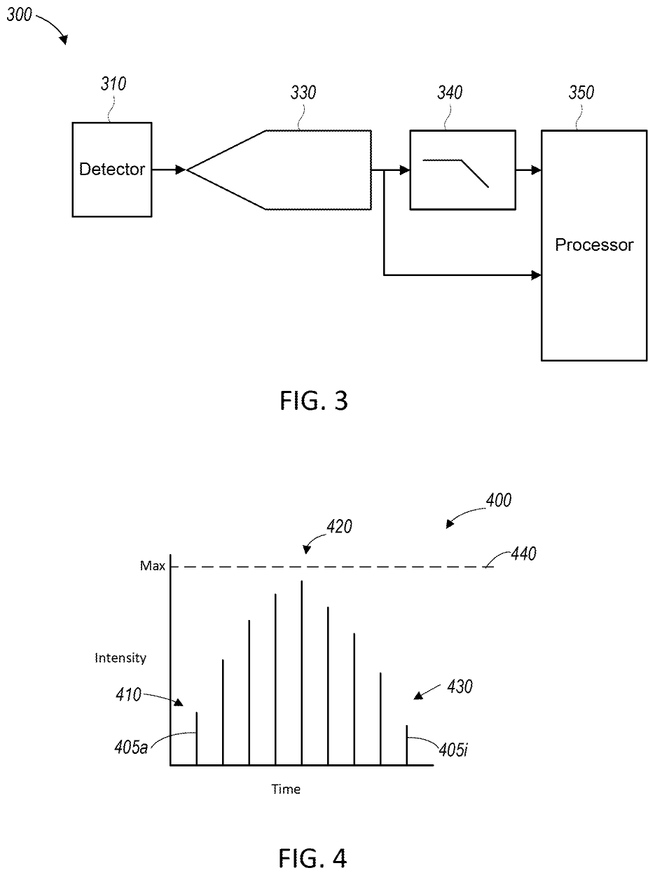

FIG. 2 describes a simplified block diagram showing aspects of a LiDAR-based detection system 200 that can be used to perform the time of flight calculations. FIG. 3 is an example schematic diagram of a receive circuit 300 that can be part of the LiDAR-based detection system 200. Receive circuit 300 can receive the reflected light signal and digitize it into a signal that can be analyzed by processor. During the digitization process the light pulse can be clipped or saturated.

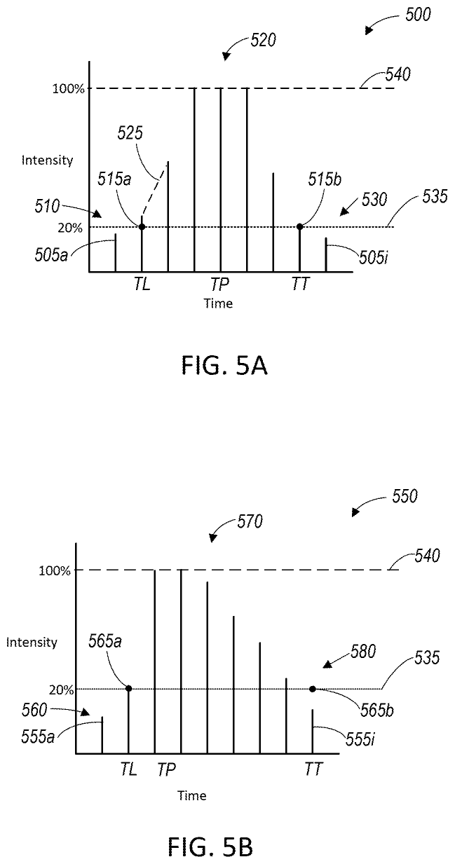

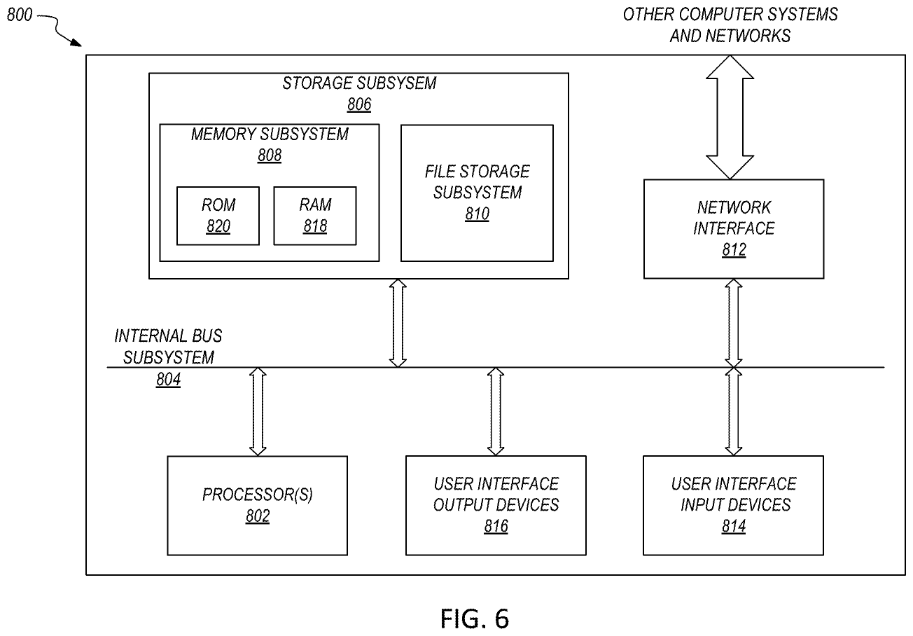

FIG. 4 shows an example of an unsaturated digitized light pulse that can be analyzed by a processor to determine a time of receipt of the light pulse. FIGS. 5A and 5B show two different examples of a saturated light pulses that have been clipped. FIG. 5A shows a Gaussian-type saturated pulse where the pulse is generally symmetric and the time of the peak is an arithmetic mean of the time of the leading edge and a time of the trailing edge. FIG. 5B is a non-Gaussian pulse where the time of the peak is offset from the arithmetic mean of the time of the leading edge and the time of the trailing edge. FIG. 6 is an example computing system that can be used with the LiDAR system described herein. These figures and the corresponding embodiments are described in more detail below.

### Example Lidar Detection System

FIG. 2 illustrates a simplified block diagram showing aspects of a LiDAR-based detection system 200, according to certain embodiments. System 200 may be configured to transmit, detect, and process LiDAR signals to perform object detection as described above with regard to LiDAR system 100 described in FIG. 1. In general, a LiDAR system 200 includes one or more transmitters (e.g., transmit block 210) and one or more receivers (e.g., receive block 250). LiDAR system 200 may further include additional systems that are not shown or described to prevent obfuscation of the novel features described herein.

Transmit block 210, as described above, can incorporate a number of systems that facilitate that generation and emission of a light signal, including dispersion patterns (e.g., 360 degree planar detection), pulse shaping and frequency control, TOF measurements, and any other control systems to enable the LiDAR system to emit pulses in the manner described above. In the simplified representation of FIG. 2, transmit block 210 can include processor(s) 220, light signal generator 230, optics/emitter module 232, power block 215 and control system 240. Some of all of system blocks 220-240 can be in electrical communication with processor(s) 220.

In certain embodiments, processor(s) 220 may include one or more microprocessors (μCs) and can be configured to control the operation of system 200. Alternatively or additionally, processor 220 may include one or more microcontrollers (MCUs), digital signal processors (DSPs), or the like, with supporting hardware, firmware (e.g., memory, programmable I/Os, or other similar device), and/or software, as would be appreciated by one of ordinary skill in the art. Alternatively, MCUs, μCs, DSPs, ASIC, programmable logic device, and the like, may be configured in other system blocks of system 200. For example, control system block 240 may include a local processor to certain control parameters (e.g., operation of the emitter). Processor(s) 220 may control some or all aspects of transmit block 210 (e.g., optics/emitter 232, control system 240, or other suitable device), receive block 250 (e.g., processor(s) 220) or any aspects of LiDAR system 200. In some embodiments, multiple processors may enable increased performance characteristics in system 200 (e.g., speed and bandwidth), however multiple processors are not required, nor necessarily germane to the novelty of the embodiments described herein. Alternatively or additionally, certain aspects of processing can be performed by analog electronic design, as would be understood by one of ordinary skill in the art.

Light signal generator 230 may include circuitry (e.g., a laser diode) configured to generate a light signal, which can be used as the LiDAR send signal, according to certain embodiments. In some cases, light signal generator 230 may generate a laser that is used to generate a continuous or pulsed laser beam at any suitable electromagnetic wavelengths spanning the visible light spectrum and non-visible light spectrum (e.g., ultraviolet and infra-red). In some embodiments, lasers are commonly in the range of 600-1200 nm, although other wavelengths are possible, as would be appreciated by one of ordinary skill in the art.

Optics/Emitter block 232 (also referred to as transmitter 232) may include one or more arrays of mirrors for redirecting and/or aiming the emitted laser pulse, mechanical structures to control spinning and/or moving of the emitter system, or other system to affect the system field-of-view, as would be appreciated by one of ordinary skill in the art with the benefit of this disclosure. For instance, some systems may incorporate a beam expander (e.g., convex lens system) in the emitter block that can help reduce beam divergence and increase the beam diameter. These improved performance characteristics may mitigate background return scatter that may add noise to the return signal. In some cases, optics/emitter block 232 may include a beam splitter to divert and sample a portion of the pulsed signal. For instance, the sampled signal may be used to initiate the TOF clock. In some cases, the sample can be used as a reference to compare with backscatter signals. Some embodiments may employ micro electromechanical mirrors (MEMS) that can reorient light to a target field. Alternatively or additionally, multi-phased arrays of lasers may be used. Any suitable system may be used to emit the LiDAR send pulses, as would be appreciated by one of ordinary skill in the art.

Power block 215 can be configured to generate power for transmit block 210, receive block 250, as well as manage power distribution, charging, power efficiency, and the like. In some embodiments, power management block 215 can include a battery (not shown), and a power grid within system 200 to provide power to each subsystem (e.g., control system 240, or other suitable device). The functions provided by power management block 215 may be subsumed by other elements within transmit block 210, or may provide power to any system in LiDAR system 200. Alternatively, some embodiments may not include a dedicated power block and power may be supplied by a number of individual sources that may be independent of one another.

Control system 240 may control aspects of light signal generation (e.g., pulse shaping), optics/emitter control, TOF timing, or any other function described herein. In some cases, aspects of control system 240 may be subsumed by processor(s) 220, light signal generator 230, or any block within transmit block 210, or LiDAR system 200 in general.

Receive block 250 may include circuitry configured to detect a process a return light pulse to determine a distance of an object, and in some cases determine the dimensions of the object, the velocity and/or acceleration of the object, and the like. Processor(s) 265 may be configured to perform operations such as processing received return pulses from detectors(s) 260, controlling the operation of TOF module 234, controlling threshold control module 280, or any other aspect of the functions of receive block 250 or LiDAR system 200 in general.

TOF module 234 may include a counter for measuring the time-of-flight of a round trip for a send and return signal. In some cases, TOF module 234 may be subsumed by other modules in LiDAR system 200, such as control system 240, optics/emitter 232, or other entity. TOF modules 234 may implement return “windows” that limit a time that LiDAR system 200 looks for a particular pulse to be returned. For example, a return window may be limited to a maximum amount of time it would take a pulse to return from a maximum range location (e.g., 250 m). Some embodiments may incorporate a buffer time (e.g., maximum time plus 10%). TOF module 234 may operate independently or may be controlled by other system block, such as processor(s) 220, as described above. In some embodiments, transmit block may also include a TOF detection module. One of ordinary skill in the art with the benefit of this disclosure would appreciate the many modification, variations, and alternative ways of implementing the TOF detection block in system 200.

Detector(s) 260 may detect incoming return signals that have reflected off of one or more objects. In some cases, LiDAR system 200 may employ spectral filtering based on wavelength, polarization, and/or range to help reduce interference, filter unwanted frequencies, or other deleterious signals that may be detected. Typically, detector(s) 260 can detect an intensity of light and records data about the return signal (e.g., via coherent detection, photon counting, analog signal detection, or the like). Detector (s) 260 can use any suitable photodetector technology including solid state photodetectors (e.g., silicon avalanche photodiodes, complimentary metal-oxide semiconductors (CMOS), charge-coupled devices (CCD), hybrid CMOS/CCD devices) or photomultipliers. In some cases, a single receiver may be used or multiple receivers may be configured to operate in parallel.

Gain sensitivity model 270 may include systems and/or algorithms for determining a gain sensitivity profile that can be adapted to a particular object detection threshold. The gain sensitivity profile can be modified based on a distance (range value) of a detected object (e.g., based on TOF measurements). In some cases, the gain profile may cause an object detection threshold to change at a rate that is inversely proportional with respect to a magnitude of the object range value. A gain sensitivity profile may be generated by hardware/software/firmware, or gain sensor model 270 may employ one or more look up tables (e.g., stored in a local or remote database) that can associate a gain value with a particular detected distance or associate an appropriate mathematical relationship there between (e.g., apply a particular gain at a detected object distance that is 10% of a maximum range of the LiDAR system, or apply a different gain at 15% of the maximum range). In some cases, a Lambertian model may be used to apply a gain sensitivity profile to an object detection threshold. The Lambertian model typically represents perfectly diffuse (matte) surfaces by a constant bidirectional reflectance distribution function (BRDF), which provides reliable results in LiDAR system as described herein. However, any suitable gain sensitivity profile can be used including, but not limited to, Oren-Nayar model, Nanrahan-Krueger, Cook-Torrence, Diffuse BRDF, Limmel-Seeliger, Blinn-Phong, Ward model, HTSG model, Fitted Lafortune Model, or the like. One of ordinary skill in the art with the benefit of this disclosure would understand the many alternatives, modifications, and applications thereof.

Threshold control block 280 may set an object detection threshold for LiDAR system 200. For example, threshold control block 280 may set an object detection threshold over a certain a full range of detection for LiDAR system 200. The object detection threshold may be determined based on a number of factors including, but not limited to, noise data (e.g., detected by one or more microphones) corresponding to an ambient noise level, and false positive data (typically a constant value) corresponding to a rate of false positive object detection occurrences for the LiDAR system. In some embodiments, the object detection threshold may be applied to the maximum range (furthest detectable distance) with the object detection threshold for distances ranging from the minimum detection range up to the maximum range being modified by a gain sensitivity model (e.g., Lambertian model).

Although certain systems may not expressly discussed, they should be considered as part of system 200, as would be understood by one of ordinary skill in the art. For example, system 200 may include a bus system (e.g., CAMBUS) to transfer power and/or data to and from the different systems therein. In some embodiments, system 200 may include a storage subsystem (not shown). A storage subsystem can store one or more software programs to be executed by processors (e.g., in processor(s) 220). It should be understood that “software” can refer to sequences of instructions that, when executed by processing unit(s) (e.g., processors, processing devices, or other suitable device), cause system 200 to perform certain operations of software programs. The instructions can be stored as firmware residing in read only memory (ROM) and/or applications stored in media storage that can be read into memory for processing by processing devices. Software can be implemented as a single program or a collection of separate programs and can be stored in non-volatile storage and copied in whole or in-part to volatile working memory during program execution. From a storage subsystem, processing devices can retrieve program instructions to execute in order to execute various operations (e.g., software-controlled spring auto-adjustment, or other suitable device) as described herein. Some software controlled aspects of LiDAR system 200 may include aspects of gain sensitivity model 270, threshold control 280, control system 240, TOF module 234, or any other aspect of LiDAR system 200.

It should be appreciated that system 200 is meant to be illustrative and that many variations and modifications are possible, as would be appreciated by one of ordinary skill in the art. System 200 can include other functions or capabilities that are not specifically described here. For example, LiDAR system 200 may include a communications block (not shown) configured to enable communication between LiDAR system 200 and other systems of the vehicle or remote resource (e.g., remote servers), or other suitable device, according to certain embodiments. In such cases, the communications block can be configured to provide wireless connectivity in any suitable communication protocol (e.g., radio-frequency (RF), Bluetooth, BLE, infra-red (IR), ZigBee, Z-Wave, Wi-Fi, or a combination thereof).

While system 200 is described with reference to particular blocks (e.g., threshold control block 280), it is to be understood that these blocks are defined for understanding certain embodiments of the invention and is not intended to imply that embodiments are limited to a particular physical arrangement of component parts. The individual blocks need not correspond to physically distinct components. Blocks can be configured to perform various operations, e.g., by programming a processor or providing appropriate processes, and various blocks may or may not be reconfigurable depending on how the initial configuration is obtained. Certain embodiments can be realized in a variety of apparatuses including electronic devices implemented using any combination of circuitry and software. Furthermore, aspects and/or portions of system 200 may be combined with or operated by other sub-systems as informed by design. For example, power management block 215 and/or threshold control block 280 may be integrated with processor(s) 220 instead of functioning as separate entities.

### Example Lidar Receive Circuit

FIG. 3 is a schematic diagram of a receive circuit 300, which may be a receive block or of a portion of a receive block, such as receive block 250 of FIG. 2. Accordingly, receive circuit 300 performs certain functions described above with respect to receive block 250. In some embodiments receive circuit 300 includes detector 310, analog-to-digital converter (ADC) 330, filter 340, and digital processor 350, however other embodiments can have different components and/or can have components arranged in a different order.

Detector 310 may have features similar or identical to detector 260 of receive block 250. For example, detector 310 be configured to receive and sense an optical light signal emitted from optics/emitter module 232 and reflected from an object of interest. In response to receiving the reflected optical light signal, detector 310 generates an analog electronic signal encoding the optical light intensity or power of the reflected light signal. For example, the analog electronic signal may have a current or voltage profile corresponding to the optical light intensity of the received light signal. Accordingly, the current or voltage value of the analog electronic signal at a particular time corresponds with the intensity of the received light signal at a corresponding time.

ADC 330 may be any analog-to-digital conversion circuit, as understood by those of skill in the art. ADC 330 receives the analog electronic signal from the detector 310 and generates a digitized representation of the analog electrical signal, which corresponds to the intensity of the received light signal. That is, the output of ADC 330 is a digital signal (e.g., a series of digitized points) that corresponds to the intensity of the reflected light signal. However, in some embodiments the received light signal can be at an unusually high intensity (e.g., when the light signal is reflected from a reflective object) which causes the ADC to saturate. More specifically, the ADC can be adjusted such that the analog signal received from the detector is within an input range of the ADC, however when an unusually intense light pulse is received the peak portion of the analog signal may exceed the maximum input range of the ADC and the ADC saturates. The saturation can cause the ADC to flatten or clip the top portion of the digitized light pulse. This is explained in greater detail in FIGS. 4 and 5, below. In other embodiments as would be appreciated by one of skill in the art, one or more digital or analog filters may also cause or contribute to clipping the digitized light pulse.

In some embodiments, the maximum input range of the ADC 330 may be changed automatically and/or with a preset value to accommodate varying expected maximum values of the raw light intensity signal. In some embodiments this adjustment can be performed with an amplifier having a variable gain, as understood by one of ordinary skill in the art.

For example, if the analog signal from detector 310 remains less than the maximum input value of the input range of the ADC 330 by an amount greater than a threshold for a time greater than a time threshold, the input range of the ADC 330 may be decreased. Similarly, if the analog signal from detector 310 remains greater than the maximum input value of the input range of the ADC 330 for a time greater than a time threshold, the input range of the ADC may be increased. Although the input range of the ADC 330 may be adjusted to accommodate average variations in intensity, it may not be able to accommodate “occasional” high intensity pulses and thus the resulting saturated pulses may need to be analyzed by processor 350 in a different way, as described in greater detail below.

In some embodiments, receive circuit 300 includes one or more analog filters (not illustrated in FIG. 3), configured to attenuate analog signal energy in one or more frequency ranges. In some embodiments, an analog filter is configured to filter the raw light intensity signal from detector 310 and produces a filtered raw light intensity signal for ADC 330. The one or more analog filters may have circuit structures understood by those of skill in the art.

In the illustrated embodiment, the digital light intensity signal is transmitted to digital filter 340, which is configured to generate a filtered digital light intensity signal, such that the filtered digital light intensity signal has frequency components of one or more frequency ranges which are attenuated. For example, filter 340 may be a matched filter configured to generate a filtered digital light intensity signal having a greater signal-to-noise ratio than the digital light intensity signal generated by ADC 330. The digital filter 340 may perform other filtering functions, and may have circuit structures understood by those of skill in the art. Digital filter 340 may include multiple filters each configured to generate a separate filtered digital light intensity signal having different frequency component characteristics. In some embodiments, filtering can be performed at other locations than shown in FIG. 3 including before or after analyses are performed by the processor.

Processor 350 receives the filtered digital light intensity signals. In this embodiment, processor 350 also receives the unfiltered digital light intensity signal generated by ADC 330. Based partly on the unfiltered digital light intensity signal and/or the filtered digital light intensity signals, processor 350 performs the functions described above with reference to any of processor(s) 220 and any of the other components of LiDAR-based detection system 200.

For example, processor 350 may be configured to calculate a distance from the detector 310 to the object of interest from which a light signal emitted from optics/emitter module 232 was reflected and received by detector 310. The distance may be calculated, for example based on a first time point corresponding with a time the light signal was emitted from optics/emitter module 232 and based on a second time point corresponding with a time the reflected light signal was received at detector 310. For example, in some embodiments the distance between the object of interest in the detector 310 is equal to the speed of light times one half the difference between the second time point and the first time point.

In one embodiment a light pulse is emitted from optics/emitter module 232, is reflected from an object of interest and the reflected light pulse is received by detector 310. The reflected light pulse can be filtered and digitized by ADC 330 and analyzed by processor 350. More specifically, a time of flight of the light pulse can be determined by calculating a time difference between a peak intensity of the transmitted light pulse and a time of peak intensity of the reflected light pulse.

Data identifying the first time point may be received by processor 350 from transmit block 210. In some embodiments, the first time point corresponds with, is, or is an estimate the time the light signal was emitted from optics/emitter module 232 and is based on an emit signal which causes optics/emitter module 232 to emit the light. For example, the emit signal may be generated by any of processor 220, light signal generator 230, optics/emitter 232, control system 240, and another system.

Various methods may be used to determine the time difference between the transmitted and the received light pulse. In some embodiments, the light signal emitted from optics/emitter module 232 is emitted as a signal pulse having a leading edge, a peak, and a trailing edge. In some embodiments, the light signal emitted from optics/emitter module 232 is a particular leading edge, peak, or trailing edge of a particular pulse of a series of light pulses. In some embodiments, the first time point corresponds with, is, or is an estimate of the time of the leading edge of the signal pulse or of a particular one of the pulses of the series of pulses. In some embodiments, the first time point corresponds with, is, or is an estimate of the time of the peak of the signal pulse or of a particular one of the pulses of the series of pulses. In some embodiments, the first time point corresponds with, is, or is an estimate of the time of the trailing edge of the signal pulse or of a particular one of the pulses of the series of pulses. In some embodiments, the light signal emitted from optics/emitter module 232 has another characteristic and the first time point corresponds with, is, or is an estimate of the time of the other characteristic of the emitted light signal.

Data identifying the second time point may be calculated by processor 350 based on the unfiltered digital light intensity signal generated by ADC 330 and/or the filtered digital light intensity signals generated by filtered 340 or one or more other filters. In some embodiments, the second time point corresponds with the time the light was received at detector 310.

In some embodiments, the light signal received at detector 310 is a signal pulse having a leading edge, a peak, and a trailing edge. In some embodiments, the light signal received at detector 310 is a particular leading edge, peak, or trailing edge of a particular pulse of a series of light pulses. In some embodiments, the second time point corresponds with, is, or is an estimate of the time of the leading edge of the signal pulse or of a particular one of the pulses of the series of pulses. In some embodiments, the second time point corresponds with, is, or is an estimate of the time of the peak of the signal pulse or of a particular one of the pulses of the series of pulses. In some embodiments, the second time point corresponds with, is, or is an estimate of the time of the trailing edge of the signal pulse or of a particular one of the pulses of the series of pulses. In some embodiments, the light signal received at detector 310 has another characteristic and the second time point corresponds with, is, or is an estimate of the time of the other characteristic of the received light signal.

### Peak Detection of Unsaturated and Saturated Light Pulses

Various methods of determining a receive time for two different types of reflected light pulses are discussed below in FIGS. 4 and 5. As discussed in further detail below, the pulse illustrated in FIG. 4 corresponds with an unsaturated light pulse which was processed by receive circuit 300 (see FIG. 3) and had a maximum intensity that was within a range of the ADC 330 and therefore has a Gaussian or near Gaussian shape. In contrast the pulse illustrated in FIG. 5 corresponds with a saturated light pulse. This pulse has a flattened top portion and is non-Gaussian in shape. The flattened top portion is caused by the maximum intensity of the received light signal being above an input range of ADC 330 (see FIG. 3), thus the region of peak intensity is flattened. As would be appreciated by one of skill in the art, using a peak intensity detection algorithm on a saturated pulse may lead to errors in time of flight calculations, as described in more detail below.

FIG. 4 is a graphical representation of a digitized unsaturated pulse 400 that can be received by processor 350. In this embodiment, unsaturated pulse 400 includes nine digitized values 405a-405i representing the intensity profile of the received light pulse. Unsaturated pulse can include a leading edge 410, a peak 420, and trailing edge 430. As understood by those of skill in the art, other embodiments of pulses can have a different number of digitized values 405a-405i, for example, as a result of the combination of pulse duration and/or ADC sampling rate. As shown in FIG. 4, all digitized values 405a-405i are below a maximum intensity of the ADC 330 (represented by line 440) thus all of the digitized values 405a-405i are representative of the intensity of the received light signal and the digitized values have a Gaussian or near Gaussian shape.

As described above, in some embodiments a time of receipt of the reflected pulse can be determined by using a peak value of the intensity of the received pulse. Because digitized pulse 400 is not saturated, peak 420 may be determined as the time of the sample of the digitized values 405a-405i having an intensity value greater than the intensity value of all of the other digitized values. In some embodiments, the time of peak 420 is calculated based on times of one or more digitized values 405a-405i that have a similar peak intensity, for example when a faster ADC is used. In further embodiments peak 420 may occur between adjacent digitized values 405a-405i.

The time of peak 420 of digitized pulse 400 may be determined using any method. For example, the time of peak 420 may be determined as the time corresponding with a digitized value 405a-405i of the series of samples having the greatest magnitude. In some embodiments, the time of peak 420 is determined as a calculated time corresponding with a time at which a curve fit to at least some of the digitized values 405a-405i has a greatest magnitude. Any curve fitting algorithm may be used. Other embodiments can use the time of leading edge 410 or of trailing edge 430 for determining a time of receipt of the received pulse.

FIG. 5A is a graphical representation of a digitized saturated pulse 500 that can be received by processor 350. In this embodiment, saturated pulse 500 includes nine digitized values 505a-505i representing the intensity profile of the received light pulse within the capabilities of the ADC 330 (see FIG. 3). Saturated pulse can include a leading edge 510, a peak 520, and trailing edge 530. As understood by those of skill in the art, other embodiments of pulses can have a different number of digitized values 505a-505i, for example, as a result of the combination of pulse duration and/or ADC sampling rate. As shown in FIG. 5A, several digitized values 505d-505f are at a maximum intensity 540 (illustrated by a dashed line at 100% intensity) of the ADC 330 thus digitized values 505d-505f are not representative of the intensity of the received light signal causing saturated pulse 500 to have a flattened or clipped (non-Gaussian) shape. FIG. 5A also illustrates a threshold intensity value 535 (shown as a dashed line) that can be used to determine a time of receipt of the saturated pulse in some embodiments, as described in more detail below.

As described above, the clipping of digitized values 505d-505f may occur, for example, if the reflected light signal received at detector 310 (see FIG. 3) has intensity values that are greater than an input range of the ADC 330. In response the ADC 330 assigns each of the digitized values 505d-505f the same maximum intensity value causing the resulting digitized pulse to have a clipped or flattened peak 520.

Because digitized pulse 500 is saturated or clipped, the time of peak 520 may not be accurately determined by using a peak searching algorithm that identifies the time of the sample having the greatest intensity value. As discussed below, the time of peak 520 may, instead, be determined as a calculated time based on one or more characteristics of saturated pulse 500, as described in more detail below.

In some embodiments a time of peak 520 can be calculated using the predetermined threshold intensity value 535 to determine a time of leading edge 510 and trailing edge 530. More specifically, in some embodiments threshold intensity value 535 can be set at a predetermined percentage of a maximum intensity 540 of the ADC 330. As shown in FIG. 5A in this example the threshold intensity value 535 is set at 20% of the maximum intensity 540, however one of skill in the art with the benefit of this disclosure will appreciate that threshold intensity value 535 can be set at any percentage of maximum intensity 540. Thus, a time of leading edge 510 of pulse 500 can be detected at a time when the first digitized intensity value equals or is greater than the threshold intensity value 535, and a time of the trailing edge can be determined at a time when the last digitized intensity value equals or is less than the threshold value. In this example the first digitized value that is equal to or that is greater than threshold value 535 is digitized value 505b, which crosses threshold value 535 at point 515a. Thus the time of leading edge 510 is determined to be TL, the time of digitized value 505b. Similarly, the time of the trailing edge in this example is determined by the last digitized value that is equal to or that is less than threshold value 535, which is digitized value 505h. Digitized value 505h is equal to threshold value 535 at point 515b, thus a time of the trailing edge 530 is TT.

In some embodiments, especially when pulse 500 is symmetric, Gaussian, or near Gaussian a time of peak 520 (labeled at TP) can be determined by calculating the arithmetic mean of the time of the leading edge 510 (labeled TL) and the time of the trailing edge (labeled as TT). This can be determined by Equation 1.

$$TP = \frac{TL + TT}{2} \qquad ( Equation 1 )$$

In some embodiments, the threshold value 535 is determined as a percentage of a full-scale or maximum intensity value 540. For example, the threshold value 535 may be equal to about 5%, about 10%, about 15%, about 20%, about 25%, about 30%, about 35%, about 40% about 45%, about 50%, about 55%, about 60%, about 65%, about 70%, or about 75% of the maximum intensity value 540. In some embodiments the threshold value 535 can be between 10% and 50% of the maximum intensity value 540, while in other embodiments the threshold value can be between 20% and 40% and in some embodiments it can be between 25% and 35%. In one embodiment the threshold value 535 can be between 7% and 13%. In some embodiments, the time of peak 520 is determined as a calculated time corresponding with a time at which a curve fit to at least some of the samples of digitized pulse 500 has a greatest magnitude. Any suitable curve fitting algorithm may be used.

The time of leading edge 510 of digitized pulse 500 may be determined using any suitable method. The time of leading edge 510 may occur at a time of one of the samples of the series. In some embodiments, the time and/or intensity value of leading edge 510 is calculated based on times and/or intensity values of one or more samples of the series. Therefore, leading edge 510 may occur at a time other than at a time of one of the samples. For example, leading edge 510 may occur between adjacent samples of the series.

In some embodiments, the time of leading edge 510 can be determined as the time corresponding with a sample adjacent and prior to the first sample in the series having the intensity value greater than the threshold 535. In some embodiments, the time of leading edge 510 is determined as the time corresponding with the sample prior to the peak 520 having an intensity value which is nearer the threshold 535 than any of the other samples prior to the peak 520.

In some embodiments, a time of leading edge 510 of digitized pulse 500 is determined as a calculated time corresponding with a time prior to the time of peak 520 at which a curve fit to at least some of the samples of digitized pulse 500 has an intensity value equal or substantially equal to threshold value 535. Any suitable curve fitting algorithm may be used. In some embodiments, the time of leading edge 510 of digitized pulse 500 is determined with a straight line interpolation calculation, for example, using an earlier sample having an intensity value less than the threshold value 535 and an adjacent later sample having an intensity value greater than the threshold value, as understood by those of skill in the art.

In some embodiments, the time of leading edge 510 of digitized pulse 500 is determined as the time corresponding with a either of first and second samples defining a first occurrence of a positive slope 525 (shown by a dashed line in FIG. 5A) greater than a threshold, where the slope is defined as a difference in intensity values of the first and second adjacent samples divided by a difference in time of the first and second samples, for example, as understood by those of skill in the art. For example, the threshold value may be a predetermined threshold value STb, such that the time of leading edge 410 is determined as the time corresponding with either of the first and second samples defining the first occurrence of the positive slope greater than threshold value STb. The threshold value STb may, for example, be equal to about 5%, about 10%, about 15%, about 20%, about 25%, about 30%, about 35%, about 40% about 45%, about 50%, about 55%, about 60%, about 65%, about 70%, or about 75%. Other intensity values for threshold value STb may be used.

In some embodiments, the time of leading edge 510 of digitized pulse 500 is determined as a calculated time corresponding with a time at which a curve fit to at least some of the samples of digitized pulse 500 has a slope 525 equal or substantially equal to threshold value STb. Any suitable curve fitting algorithm may be used.

In some embodiments, the time of leading edge 510 of digitized pulse 500 is determined as the time corresponding with either of first and second samples defining a maximum slope of a plurality of slopes, where the plurality of slopes includes each of slopes defined by the samples of the digitized pulse 500, as understood by those of skill in the art. Accordingly, in such embodiments, the time of leading edge 510 of digitized pulse 500 corresponds with an inflection point in the rising portion of digitized pulse 500.

In some embodiments, the time of leading edge 510 of digitized pulse 500 is determined as a calculated time corresponding with a time at which a curve fit to at least some of the samples of digitized pulse 500 has a slope equal or substantially equal to a maximum slope of the curve. Any suitable curve fitting algorithm may be used. Accordingly, in such embodiments, the time of leading edge 510 of digitized pulse 500 corresponds with an inflection point in the rising portion of digitized pulse 500.

The time of trailing edge 530 of digitized pulse 500 may be determined using any method. Trailing edge 530 may occur at a time of one of the samples of the series. In some embodiments, the time and/or intensity value of trailing edge 530 is calculated based on times and/or intensity values of one or more samples of the series. Therefore, trailing edge 530 may occur at a time other than at a time of one of the samples. For example, trailing edge 530 may occur between adjacent samples of the series.

In some embodiments, the time of trailing edge 530 of digitized pulse 500 is determined as the time corresponding with a first sample in the series after the peak 520 having an intensity value less than a threshold. For example, the threshold value may be a predetermined threshold value Te, such that the time of trailing edge 530 is determined as the time corresponding with the first sample in the series after the peak 520 having an intensity value less than Te. In some embodiments, the time of trailing edge 530 is determined as the time corresponding with a sample adjacent and prior to the first sample in the series after the peak 520 having the intensity value less than the threshold. In some embodiments, the time of trailing edge 530 is determined as the time corresponding with the sample after the peak 520 having an intensity value which is nearer the threshold than any of the other samples after the peak 520.

In some embodiments, the threshold value Te is determined as a percentage of a full-scale or maximum intensity value possible for the digitized pulse 500, or of the intensity value of the peak 520. For example, the threshold value Te may be equal to about 5%, about 10%, about 15%, about 20%, about 25%, about 30%, about 35%, about 40% about 45%, about 50%, about 55%, about 60%, about 65%, about 70%, or about 75% of the full-scale output intensity value of the circuit generating digitized pulse 500.

In some embodiments, threshold value Te is equal to threshold value Tb. In some embodiments, threshold value Te is not equal to threshold value Tb.

In some embodiments, the time of trailing edge 530 of digitized pulse 500 is determined as a calculated time corresponding with a time after the time of the peak 520 at which a curve fit to at least some of the samples of digitized pulse 500 has an intensity value equal or substantially equal to threshold value Te. Any curve fitting algorithm may be used. In some embodiments, the time of trailing edge 530 of digitized pulse 500 is determined with a straight line interpolation calculation, for example, using an earlier sample having an intensity value greater than the threshold value Te and an adjacent later sample having an intensity value less than the threshold value Te, as understood by those of skill in the art.

In some embodiments, the time of trailing edge 430 of digitized pulse 400 is determined as the time corresponding with a either of first and second samples defining a last occurrence of a negative slope having a magnitude greater than a threshold, where the slope is defined as a difference in intensity values of the first and second samples divided by a difference in time of the first and second samples, for example, as understood by those of skill in the art. For example, the threshold value may be a predetermined threshold value STe, such that the time of trailing edge 430 is determined as the time corresponding with either of the first and second samples defining the last occurrence of the negative slope having the magnitude greater than threshold value STe. The threshold value STe may, for example, be equal to about 5%, about 10%, about 15%, about 20%, about 25%, about 30%, about 35%, about 40% about 45%, about 50%, about 55%, about 60%, about 65%, about 70%, or about 75%. Other suitable intensity values for threshold value STe may be used.

In some embodiments, the time of trailing edge 530 of digitized pulse 500 is determined as a calculated time corresponding with a time at which a curve fit to at least some of the samples of digitized pulse 500 has a slope equal or substantially equal to threshold value STe. Any suitable curve fitting algorithm may be used.

In some embodiments, threshold value STe is equal to threshold value STb. In some embodiments, threshold value STe is not equal to threshold value STb.

In some embodiments, the time of trailing edge 530 of digitized pulse 500 is determined as the time corresponding with either of first and second samples defining a minimum slope of a plurality of slopes, where the plurality of slopes includes each of the slopes defined by the samples of the digitized pulse 500, as understood by those of skill in the art. Accordingly, in such embodiments, the time of trailing edge 530 of digitized pulse 500 corresponds with an inflection point in the falling portion of digitized pulse 500.

In some embodiments, the time of trailing edge 530 of digitized pulse 500 is determined as a calculated time corresponding with a time at which a curve fit to at least some of the samples of digitized pulse 500 has a slope equal or substantially equal to a minimum slope of the curve. Any suitable curve fitting algorithm may be used. Accordingly, in such embodiments, the time of trailing edge 530 of digitized pulse 500 corresponds with an inflection point in the falling portion of digitized pulse 500.

Because digitized pulse 500 is not saturated, peak 520 may be determined as the time of the sample of the series having an intensity value greater than the intensity value of all of the other samples. In contrast, digitized pulses which are unsaturated, may use an alternative method of determining the time of peak intensity as described with regard to FIG. 4.

FIG. 5B is a graphical representation of a digitized saturated pulse 550 that can be received by processor 350. Saturated pulse 550 is similar to saturated pulse 500 in FIG. 5A, however saturated pulse 550 is non-Gaussian and has a steeper leading edge 560 and a shallower trailing edge 580 than pulse 500 in FIG. 5A. In this embodiment, saturated pulse 550 includes nine digitized values 555a-555i representing the intensity profile of the received light pulse within the capabilities of the ADC 330 (see FIG. 3). Saturated pulse 550 can include a leading edge 560, a peak 570, and trailing edge 580. As shown in FIG. 5B, several digitized values 555c-555d are at a maximum intensity 540 (illustrated by a dashed line at 100% intensity) of the ADC 330 thus digitized values 555c-555d are not representative of the intensity of the received light signal causing saturated pulse 550 to have a flattened or clipped shape. FIG. 5A also illustrates a threshold intensity value 535 (shown as a dashed line) that can be used to determine a time of receipt of the saturated pulse in some embodiments, as described in more detail below.

Similar to pulse 500 described in FIG. 5A, because digitized pulse 550 is saturated or clipped, the time of peak 570 may not be accurately determined by using a peak searching algorithm that identifies the time of the sample having the greatest intensity value. Thus the time of peak 570 may, instead, be determined as a calculated time based on one or more characteristics of saturated pulse 550, as described in more detail below. Because pulse 550 is not Gaussian, Equation 1 may not provide an accurate determination of the time of peak 570, thus a different equation may be used. In some embodiments the shape of pulse 550 may be known such that a modified version of Equation 1 can be used. More specifically, in some embodiments Equation 1 with an offset value can be used.

$$TP = \frac{TL + TT}{2} + offset \qquad ( Equation 2 )$$

In some embodiments the offset value can be determined by detecting a time of a leading edge (identified as TL) at point 565a where the pulse crosses threshold 535 and a time of a trailing edge (identified as TT) at point 565b where the pulse crosses the threshold again. Accordingly, For example, if it is known from characterization of the pulses that the peak is typically offset towards the leading edge 560 where ⅓ of the pulse width is between the leading edge and the peak 570 and ⅔ of the pulse width is between the peak 570 and the trailing edge 580, Equation 2 now becomes Equation 3.

$$TP = \frac{TL + 2 TT}{3} \qquad ( Equation 3 )$$

As would be appreciated by one of skill in the art with the benefit of this disclosure the offset of Equation 2 can be adjusted for any known parameters of the pulse. In some embodiments, the time of peak 570 may be determined as a calculated time based on the time of leading edge 560. For example, the time of peak 570 may be determined as a delay time Tfb occurring after leading edge 560.

In some embodiments, the delay time Tfb is determined based on one or more known characteristics of the light signal emitted from optics/emitter module 232. For example, the peak of the light signal emitted from optics/emitter module 232 may occur a known time after a leading edge of the light signal emitted from optics/emitter module 232, and the delay time Tfb may set to be equal to the known time. Other characteristics of the light signal emitted from optics/emitter module 232 may be used to determine the delay time Tfb. The characteristics of the light signal emitted from optics/emitter module 232 used to determine the delay time Tfb may be determined based on one or more signals generated in transmit block 210 which cause optics/emitter module 232 to emit the light signal emitted therefrom.

In some embodiments, the delay time Tfb is determined based on one or more known characteristics of the light signal received at detector 310. For example, the peak 570 of the light signal received at detector 310 may occur a known delay time Tfb after the leading edge 560. Other characteristics of the light signal received at detector 310 may be used to determine the delay time Tfb. The characteristics of the light signal received at detector 310 used to determine the delay time Tfb may be known from a characterization performed on multiple light signals received at detector 310. For example, a sample delay time between a leading edge and a peak of each of the multiple light signals received at detector 310 may be calculated, where the time of peak is determined using another method and the time of the leading edge is determined using the same method as that used to determine the time of leading edge 560. An average of the sample delay times may, for example, be used as the delay time Tfb for determining the time of peak 570 based on the time of leading edge 410.

In some embodiments, the time of peak 570 may be determined as a calculated time based on the time of trailing edge 580. For example, the time of peak 570 may be determined as a delay time Tfe occurring before trailing edge 580.

In some embodiments, the delay time Tfe is determined based on one or more known characteristics of the light signal emitted from optics/emitter module 232. For example, the peak of the light signal emitted from optics/emitter module 232 may occur a known time before a trailing edge of the light signal emitted from optics/emitter module 232, and the delay time Tfe may set to be equal to the known time. Other characteristics of the light signal emitted from optics/emitter module 232 may be used to determine the delay time Tfe. The characteristics of the light signal emitted from optics/emitter module 232 used to determine the delay time Tfe may be determined based on one or more signals generated in transmit block 210 which cause optics/emitter module 232 to emit the light signal emitted therefrom.

In some embodiments, the delay time Tfe is determined based on one or more known characteristics of the light signal received at detector 310. For example, the peak 570 of the light signal received at detector 310 may occur a known delay time Tfe before the trailing edge 580. Other characteristics of the light signal received at detector 310 may be used to determine the delay time Tfe. The characteristics of the light signal received at detector 310 used to determine the delay time Tfe may be known from a characterization performed on multiple light signals received at detector 310. For example, a sample delay time Tfe between a peak and a trailing edge of each of the multiple light signals received at detector 310 may be calculated, where the time of the peak is determined using another method, and the time of the trailing edge is determined using the same method as that used to calculate trailing edge 580. An average of the sample delay times may be used as the delay time Tfe for determining the time of peak 570 based on the time of trailing edge 580.

In some embodiments, the time of peak 570 may be determined as a calculated time based on both the time of leading edge 560 and the time of trailing edge 580. For example, the time of peak 570 may be determined as a mathematical function of both the time of leading edge 560 and the time of trailing edge 580.

In some embodiments, the time of peak 570 is determined based on one or more known characteristics of the light signal emitted from optics/emitter module 232. For example, the peak of the light signal emitted from optics/emitter module 232 may occur according to a known mathematical function of the time of the leading edge and the time of trailing edge of the light signal emitted from optics/emitter module 232, and the mathematical function used to determine the time of peak 570 based on the time of leading edge 560 and the time of trailing edge 580 may be the same known mathematical function. For example, it may be known that the peak in the light signal emitted from optics/emitter module 232 occurs after the leading edge by a particular portion of the time between the leading edge and the trailing edge. For example, as a non-limiting example, it may be known that the peak in the light signal emitted from optics/emitter module 232 occurs after the leading edge by a ⅓ of the time between the leading edge and the trailing edge of the light signal emitted from optics/emitter module 232, and peak 420 may be calculated as occurring after leading edge 410 by ⅓ the time difference between leading edge 410 and trailing edge 430.

Other characteristics of the light signal emitted from optics/emitter module 232 may be used to determine the mathematical function used to determine the time of peak 570 based on the time of leading edge 560 and the time of trailing edge 580. The characteristics of the light signal emitted from optics/emitter module 232 used to determine the mathematical function used to determine the time of peak 570 based on the time of leading edge 560 and the time of trailing edge 580 may be determined, for example, based on one or more signals generated in transmit block 210 which cause optics/emitter module 232 to emit the light signal emitted therefrom.

In some embodiments, the mathematical function used to determine the time of peak 570 based on the time of leading edge 560 and the time of trailing edge 580 is determined based on one or more known characteristics of the light signal received at detector 310. For example, the peak 570 of the light signal received at detector 310 may occur at a time according to a known mathematical function of the time of leading edge 560 and the time of trailing edge 580. The known mathematical function of the time of leading edge 560 and the time of trailing edge 580 used to determine the time of peak 570 may be known from a characterization performed on multiple light signals received at detector 310. For example, sample times for a leading edge, a peak, and a trailing edge of each of the multiple light signals received at detector 310 may be determined, where the time of peak is determined using another method, and the time of the leading edge and the time of the trailing edge are respectively determined using the same method as that used to calculate the time of leading edge 560 and the time of trailing edge 580. The sample times may be used to calculate an average time occurrence of the peaks relative to the times of the leading edges and the trailing edges. For example, the sample times of the multiple light signals may be used to determine that the peak occurs after the leading edge, on average, a particular portion of the time between the leading edge and the time of trailing edge. As a non-limiting example, the average particular portion may be ⅓, and peak 570 may be calculated as occurring after leading edge 560 by ⅓ the time difference between leading edge 560 and trailing edge 580.

In some embodiments, a digitized pulse may have a leading edge at a negative slope portion of the pulse, and a trailing edge at a positive slope portion of the pulse. As understood by those of skill in the art, in such embodiments, as understood by those of ordinary skill in the art, determination of the leading edge, the peak, and the trailing edge may be made based on the principles described herein with minor modification, such as by identifying intensity values greater than a threshold instead of less than the threshold, or by identifying intensity values less than a threshold instead of greater than the threshold, as described herein for the digitized pulses having a leading edge at a positive slope portion of the pulse, and a trailing edge at a negative slope portion of the pulse.

Once the times of leading edge 560, peak 570, and/or trailing edge 580 are determined TOF module 234 or another circuit or module may use the determined times to calculate a time of flight based on the determined times and one or more times of the leading edge, peak, or trailing edge of the light signal emitted by optics/emitter module 232.

The time of flight may be calculated using any method. For example, a time of flight may be calculated as the difference between the times of peak 570 and the peak of the light signal emitted by optics/emitter module 232. As understood by those of skill in the art, the time-of-flight may be calculated using other methods.

Once the time of flight is determined, a range of the object of interest or a distance between the detector 310 and the object of interest may be calculated based on the time of flight. The distance may be calculated using any method. For example, the distance may be calculated as one half the time of flight times the speed of light.

In some embodiments, for a series of digitized pulses, a first time of a first leading edge of a first digitized pulse, such as one of digitized pulses 400, 500 or 550 is identified using a first method, such as any of those described herein, and a second time of a second leading edge of a second pulse, such as any of digitized pulses 400, 500 or 550, is identified using a second method, such as any of those described herein. In some embodiments, for a series of digitized pulses, a first time of a first trailing edge of a first digitized pulse, such as any of digitized pulses 400, 500 and 550, is identified using a first method, and a second time of a second trailing edge of a second pulse, such as any of digitized pulses 400, 500 and 550, is identified using a second method, such as any of those described herein.

In some embodiments, for a series of digitized pulses, a first time of a first peak of a first digitized pulse, such as any of digitized pulses 400, 500 and 550, is identified using a first method, such as any of those described herein, and a second time of a second peak of a second pulse, such as any of digitized pulses 400, 500 and 550, is identified using a second method, such as any of those described herein. For example, for a series of digitized pulses, a first time of a first peak of a first digitized pulse, such as digitized pulse 400, is identified as the time of the sample having the greatest magnitude, and a second time of a second peak of a second pulse, such as digitized pulse 500, is identified based on a time of a leading edge and a trailing edge of the second pulse, for example, using a method described above.

Any of the methods described above with regard to FIGS. 5A and 5B that are used to determine a time of receipt of a pulse can be used with regard to unsaturated pulse 400 in FIG. 4.

### Example Lidar Computing System

FIG. 6 is a simplified block diagram of computer system 800 configured to operate aspects of a LiDAR-based detection system, according to certain embodiments. Computer system 800 can be used to implement any of the systems and modules discussed herein. For example, computer system 800 may operate aspects of threshold control 280, TOF module 234, processor(s) 220, control system 240, or any other element of LiDAR system 200 or other system described herein. Computer system 800 can include one or more processors 802 that can communicate with a number of peripheral devices (e.g., input devices) via a bus subsystem 804. These peripheral devices can include storage subsystem 806 (comprising memory subsystem 808 and file storage subsystem 810), user interface input devices 814, user interface output devices 816, and a network interface subsystem 812.

In some examples, internal bus subsystem 804 (e.g., CAMBUS) can provide a mechanism for letting the various components and subsystems of computer system 800 communicate with each other as intended. Although internal bus subsystem 804 is shown schematically as a single bus, alternative embodiments of the bus subsystem can utilize multiple buses. Additionally, network interface subsystem 812 can serve as an interface for communicating data between computer system 800 and other computer systems or networks. Embodiments of network interface subsystem 812 can include wired interfaces (e.g., Ethernet, CAN, RS232, RS485, or other suitable interface) or wireless interfaces (e.g., ZigBee, Wi-Fi, cellular, or other suitable device).

In some cases, user interface input devices 814 can include a keyboard, pointing devices (e.g., mouse, trackball, touchpad, or other suitable device), a barcode scanner, a touch-screen incorporated into a display, audio input devices (e.g., voice recognition systems, microphones, or other suitable device), Human Machine Interfaces (HMI) and other types of input devices. In general, use of the term “input device” is intended to include all possible types of devices and mechanisms for inputting information into computer system 800. Additionally, user interface output devices 816 can include a display subsystem, a printer, or non-visual displays such as audio output devices, or other suitable device. The display subsystem can be any known type of display device. In general, use of the term “output device” is intended to include all possible types of devices and mechanisms for outputting information from computer system 800.

Storage subsystem 806 can include memory subsystem 808 and file/disk storage subsystem 810. Subsystems 808 and 810 represent non-transitory computer-readable storage media that can store program code and/or data that provide the functionality of embodiments of the present disclosure. In some embodiments, memory subsystem 808 can include a number of memories including main random access memory (RAM) 818 for storage of instructions and data during program execution and read-only memory (ROM) 820 in which fixed instructions may be stored. File storage subsystem 810 can provide persistent (i.e., non-volatile) storage for program and data files, and can include a magnetic or solid-state hard disk drive, an optical drive along with associated removable media (e.g., CD-ROM, DVD, Blu-Ray, or other suitable device), a removable flash memory-based drive or card, and/or other types of storage media known in the art.

It should be appreciated that computer system 800 is illustrative and not intended to limit embodiments of the present disclosure. Many other configurations having more or fewer components than system 800 are possible.

The various embodiments further can be implemented in a wide variety of operating environments, which in some cases can include one or more user computers, computing devices or processing devices, which can be used to operate any of a number of applications. User or client devices can include any of a number of general purpose personal computers, such as desktop or laptop computers running a standard operating system, as well as cellular, wireless and handheld devices running mobile software and capable of supporting a number of networking and messaging protocols. Such a system also can include a number of workstations running any of a variety of commercially available operating systems and other known applications for purposes such as development and database management. These devices also can include other electronic devices, such as dummy terminals, thin-clients, gaming systems and other devices capable of communicating via a network.

Most embodiments utilize at least one network that would be familiar to those skilled in the art for supporting communications using any of a variety of commercially available protocols, such as TCP/IP, UDP, OSI, FTP, UPnP, NFS, CIFS, and the like. The network can be, for example, a local-area network, a wide-area network, a virtual private network, the Internet, an intranet, an extranet, a public switched telephone network, an infrared network, a wireless network, and any combination thereof.

In embodiments utilizing a network server, the network server can run any of a variety of server or mid-tier applications, including HTTP servers, FTP servers, CGI servers, data servers, Java servers, and business application servers. The server(s) also may be capable of executing programs or scripts in response to requests from user devices, such as by executing one or more applications that may be implemented as one or more scripts or programs written in any programming language, including but not limited to Java®, C, C# or C++, or any scripting language, such as Perl, Python or TCL, as well as combinations thereof. The server(s) may also include database servers, including without limitation those commercially available from Oracle®, Microsoft®, Sybase®, and IBM®.

The environment can include a variety of data stores and other memory and storage media as discussed above. These can reside in a variety of locations, such as on a storage medium local to (and/or resident in) one or more of the computers or remote from any or all of the computers across the network. In a particular set of embodiments, the information may reside in a storage-area network (SAN) familiar to those skilled in the art. Similarly, any necessary files for performing the functions attributed to the computers, servers or other network devices may be stored locally and/or remotely, as appropriate. Where a system includes computerized devices, each such device can include hardware elements that may be electrically coupled via a bus, the elements including, for example, at least one central processing unit (CPU), at least one input device (e.g., a mouse, keyboard, controller, touch screen or keypad), and at least one output device (e.g., a display device, printer or speaker). Such a system may also include one or more storage devices, such as disk drives, optical storage devices, and solid-state storage devices such as RAM or ROM, as well as removable media devices, memory cards, flash cards, or other suitable device.

Such devices also can include a computer-readable storage media reader, a communications device (e.g., a modem, a network card (wireless or wired), an infrared communication device, or other suitable device), and working memory as described above. The computer-readable storage media reader can be connected with, or configured to receive, a non-transitory computer readable storage medium, representing remote, local, fixed, and/or removable storage devices as well as storage media for temporarily and/or more permanently containing, storing, transmitting, and retrieving computer-readable information. The system and various devices also typically will include a number of software applications, modules, services or other elements located within at least one working memory device, including an operating system and application programs, such as a client application or browser. It should be appreciated that alternate embodiments may have numerous variations from that described above. For example, customized hardware might also be used and/or particular elements might be implemented in hardware, software (including portable software, such as applets) or both. Further, connection to other computing devices such as network input/output devices may be employed.

Non-transitory storage media and computer-readable storage media for containing code, or portions of code, can include any appropriate media known or used in the art such as, but not limited to, volatile and non-volatile, removable and non-removable media implemented in any method or technology for storage of information such as computer-readable instructions, data structures, program modules or other data, including RAM, ROM, Electrically Erasable Programmable Read-Only Memory (EEPROM), flash memory or other memory technology, CD-ROM, DVD or other optical storage, magnetic cassettes, magnetic tape, magnetic disk storage or other magnetic storage devices or any other medium which can be used to store the desired information and which can be accessed by a system device. Based on the disclosure and teachings provided herein, a person of ordinary skill in the art will appreciate other ways and/or methods to implement the various embodiments. However, computer-readable storage media does not include transitory media such as carrier waves or the like.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. The phrase “based on” should be understood to be open-ended, and not limiting in any way, and is intended to be interpreted or otherwise read as “based at least in part on,” where appropriate. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the disclosure and does not pose a limitation on the scope of the disclosure unless otherwise claimed. No language in the specification should be construed as indicating any non-claimed element as essential to the practice of the disclosure.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed is:

1. A range detection system, comprising:
an optical source configured to emit an optical pulse toward an object, wherein the emitted optical pulse comprises a peak intensity occurring at a first time, and wherein the emitted optical pulse is reflected from the object, whereby a reflected optical pulse is generated;
an optical detector configured to receive the reflected optical pulse and to generate an electronic signal encoding the received reflected optical pulse; and
a processor, configured to receive the electronic signal and to:
detect a leading edge occurring at a second time;
detect a trailing edge occurring at a third time; and
calculate an estimated time of a peak intensity of the reflected optical pulse based at least in part on a difference between the second time and the third time.

2. The range detection system of claim 1, wherein the leading edge and the trailing edge of the electronic signal are each detected when the electronic signal crosses a predetermined threshold value.

3. The range detection system of claim 2, wherein the predetermined threshold value is set at a percentage of a maximum value of the electronic signal.

4. The range detection system of claim 1, wherein the estimated time of the peak intensity is calculated as an arithmetic mean of the second time and the third time.

5. The range detection system of claim 4, wherein the estimated time of the peak intensity is calculated based on the arithmetic mean adjusted by an offset value.

6. The range detection system of claim 5, wherein the offset value is determined based on a characterization of one or more optical signals received by the optical detector.

7. The range detection system of claim 1, wherein the leading edge of the electronic signal is detected based on a first slope of the electronic signal, and the trailing edge of the electronic signal is detected based on a second slope of the electronic signal.

8. A LiDAR receiver comprising:
an optical receiver configured to receive a reflected LiDAR pulse; and
circuitry coupled to the optical receiver and configured to use a predetermined threshold intensity value to:
determine a time of a leading edge of the reflected pulse at a time when an intensity of the reflected LiDAR pulse crosses the predetermined threshold intensity value a first time;
determine a time of a trailing edge of the reflected pulse at a time when an intensity of the reflected LiDAR pulse crosses the threshold intensity value a second time; and
determine an estimated time of a peak intensity of the reflected LiDAR pulse using the time of the leading edge and the time of the trailing edge.

9. The LiDAR receiver of claim 8, wherein the predetermined threshold intensity value is set at a percentage of a saturation intensity of the LiDAR receiver.

10. The LiDAR receiver of claim 9, wherein the percentage is between 20 percent and 40 percent.

11. The LiDAR receiver of claim 8, wherein the estimated time of the peak intensity is determined by calculating an arithmetic mean of the time of the leading edge and the time of the trailing edge.

12. The LiDAR receiver of claim 11, wherein the estimated time of the peak intensity is offset from the arithmetic mean.

13. The LiDAR receiver of claim 12, wherein a value of the offset is determined based on characterization of one or more received LiDAR pulses.

14. The LiDAR receiver of claim 8, wherein a leading edge slope of the reflected pulse is determined at the first time and a falling edge slope of the reflected pulse is determined at the second time, and wherein at least one of the leading edge slope and the falling edge slope are used in the determining the estimated time of the peak intensity.

15. A method of determining a distance to an object, the method comprising:
emitting an optical signal from an optical source toward the object, wherein the emitted optical signal comprises a peak intensity occurring at a first time, wherein the emitted optical signal is reflected from the object, whereby a reflected optical signal is generated;
receiving the reflected optical signal at an optical detector;
generating an electronic signal encoding the received reflected optical signal, wherein the electronic signal encodes a leading edge occurring at a second time and a trailing edge occurring at a third time;
calculating an estimated time of a peak intensity of the electronic signal at a fourth time based at least in part on the second time and the third time; and
determining the distance to the object based at least in part on a difference between the first time and the fourth time.

16. The method of claim 15, further comprising determining the second time and the third time when the electronic signal crosses a predetermined threshold value.

17. The method of claim 16, wherein the predetermined threshold value is set between 20 percent and 40 percent of a maximum value of the electronic signal.

18. The method of claim 15, further comprising:
determining the second time based on a first slope of the electronic signal; and
determining the third time based on a second slope of the electronic signal.

19. The method of claim 15, wherein the estimated time of the peak intensity is calculated by determining an arithmetic mean of the second time and the third time.

20. The method of claim 19, wherein the estimated time of the peak intensity is calculated by adding an offset value to the arithmetic mean.
